(19) United States
(12) Patent Application Publication
(10) Pub. No.: US 2009/0204724 A1
(43) Pub. Date: Aug. 13, 2009

(54) SOAP ROUTING METHOD, ROUTING SYSTEM AND RELEVANT DEVICES

(75) Inventors: Yawen Xiao, Shenzhen (CN); Qifeng Ma, Shenzhen (CN); Xianjun Zou, Shenzhen (CN)

Correspondence Address: BRINKS HOFER GILSON & LIONE, P.O. BOX 10395, CHICAGO, IL, 60610, US

(73) Assignee: Huawei Technologies Co., Ltd., Shenzhen (CN)

(21) Appl. No.: 12/424,167

(22) Filed: Apr. 15, 2009

Related U.S. Application Data
(63) Continuation of application No. PCT/CN2008/071736, filed on Jul. 24, 2008.

(30) Foreign Application Priority Data
Jul. 27, 2007 (CN) 200710137636.0

(51) Int. Cl. G06F 15/173

(52) U.S. Cl. 709/243

(57) ABSTRACT

A SOAP routing method includes receiving a SIP request message from a service requester where the SIP request message carries application QoS information and service description information, selecting a SOAP intermediate node and a service provider according to the application QoS information and service description information, obtaining the SOAP routing information according to the SOAP intermediate node and service provider, and sending the SIP request message carrying the SOAP routing information to the corresponding service provider. In addition, a routing system and relevant devices are provided.

This application claims priority from the Chinese Patent Application No. 200710137636.0, filed with the Chinese Patent Office on Jul. 27, 2007 and entitled “SOAP Routing Method, Routing System and Relevant Devices”, the contents of which are incorporated herein by reference in their entirety.

### FIELD OF THE DISCLOSURE

The present disclosure relates to the communication field, and in particular, to a Simple Object Access Protocol (SOAP) routing method, routing system and relevant devices.

### DISCUSSION OF THE RELATED ART

With the development of network technologies, the SOAP-based application services are put into use. Although the SOAP is highly interoperable, the execution efficiency and security defects of the SOAP directly affect the Quality of Service (QoS) of the SOAP-based applications of the service requesters and service providers. The QoS here refers to non-functional attributes such as performance, availability, and security. Therefore, it is proposed in the communication industry that a dedicated SOAP intermediate node should be added between the service provider and the service requester to decompose the functions (such as compression, encryption and authentication) to be performed by the service provider and service requester and improve the application QoS of the service requester and service provider, thus imposing requirements on the SOAP message routing.

A SOAP routing method in the related art is as follows.

Through Web Services Description Language (WSDL) or manual input, the SOAP path information is obtained. The WS-Routing protocol is used to define the routing path of the SOAP message. According to this protocol, a route or transmission path may be defined from the message source through several intermediate nodes to the final receiver of the message. Along this routing path, the message of the service requester arrives at the specified service provider through the specified SOAP intermediate nodes.

However, in the related art, the SOAP intermediate nodes in the transmission process of the SOAP message are allocated fixedly; it is not possible to configure or change the SOAP routing path dynamically according to the system status (such as occupation rate and function features) of the SOAP intermediate nodes and the service provider. Consequently, certain SOAP intermediate node may be overloaded, and the session-based SOAP routing is not supported. Moreover, the granularity of SOAP routing is coarse, and does not enable a service requester to interact in different SOAP sessions or adopt different SOAP routing paths.

### SUMMARY

A SOAP routing method includes receiving, by a routing controller, a Session Initiation Protocol (SIP) request message from a service requester, where the SIP request message carries application QoS information and service description information; selecting a SOAP intermediate node and a service provider according to the application QoS information and service description information; obtaining SOAP routing information according to the SOAP intermediate node and service provider; and sending the SIP request message carrying the SOAP routing information to the service provider.

A routing system includes:

a service requester adapted to send a SIP request message carrying application QoS information and service description information, receive a SIP response message carrying SOAP routing information, send a SOAP request message carrying session-based routing information, and receive a SOAP response message;

a routing controller adapted to receive the SIP request message from the service requester, select a SOAP intermediate node and a service provider according to the application QoS information and service description information, obtain the SOAP routing information according to the SOAP intermediate node and service provider, and send the SIP request message carrying the SOAP routing information to the service provider;

the service provider adapted to return the SIP response message and SOAP response message which carry the SOAP routing information to the service requester.

A routing controller includes a receiving unit adapted to receive a SIP request message from a service requester; a routing information obtaining unit adapted to obtain SOAP routing information according to application QoS information and service description information in the request message in view of the capability and status of a SOAP intermediate node and the status of a service provider; and a sending unit adapted to send the SIP request message carrying the SOAP routing information to the service provider corresponding to the SOAP route.

A SOAP intermediate node includes a service processing unit adapted to perform service processing for a received SOAP request message; and a forwarding unit adapted to forward the SOAP request message which has undergone the service processing.

A service provider includes a session managing unit adapted to create a session context according to a session ID in a received SIP request; and a message processing unit adapted to process a SOAP request message according to the session context created by the session managing unit.

A service requester includes a session request sending unit adapted to send a SIP request message; a routing managing unit adapted to perform route negotiation through the SIP message and generate and store a session-based SOAP routing path; and a service request sending unit adapted to send a SOAP request message through the SOAP routing path generated by the routing managing unit.

In the embodiments of the present invention, the routing controller performs SOAP routing by selecting a proper SOAP intermediate node and service provider according to the QoS parameters and service description information received from the service requester in view of the capability and status of the SOAP intermediate node and the service provider, thus balancing the load between nodes and improving the system performance.

### BRIEF DESCRIPTION OF THE DRAWINGS

FIG. 1 is a general flowchart of a SOAP routing method;

FIG. 2 is a flowchart of obtaining SOAP routing information

FIG. 3 is a flowchart of routing a SOAP message;

FIG. 4 is a flowchart of changing a routing path;

FIG. 5 shows a routing system;

FIG. 6 shows a routing controller;

FIG. 7 shows a SOAP intermediate node;

FIG. 8 shows a service provider; and

FIG. 9 shows a service requester.

### DETAILED DESCRIPTION OF THE DISCLOSURE

In the embodiments of the present disclosure, the routing controller selects and changes the SOAP routing path dynamically and determines the destination address of the service provider instance according to the application QoS information and service description information carried in the SIP request message in view of the capability and status of the SOAP intermediate node and the status of the service provider, thus balancing the load between nodes and improving the system performance.

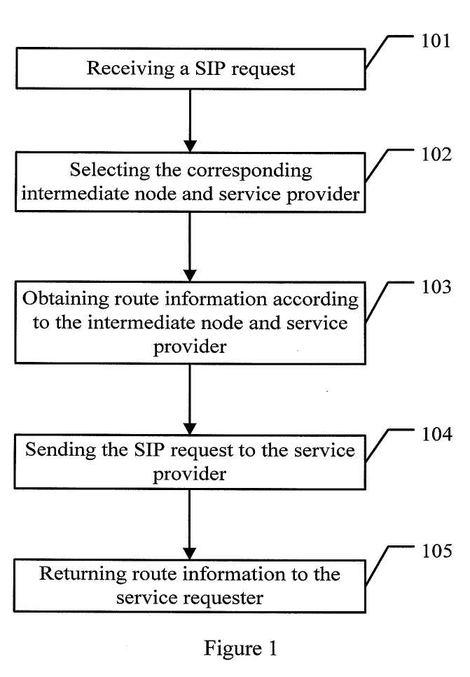

The SOAP routing method provided in an embodiment of the present disclosure is detailed below. As shown in FIG. 1, the SOAP routing method includes the following steps:

101. A SIP request message is received.

The routing controller receives the SIP request message from a service requester, where the SIP request message carries application QoS information and service description information.

102. The corresponding SOAP intermediate node and service provider are selected.

According to the received SIP request message, the routing controller selects the SOAP intermediate node and service provider that comply with the application QoS information.

103. Routing information is obtained according to the information about the SOAP intermediate node and service provider.

After selecting the SOAP intermediate node and service provider compliant with the conditions, the routing controller generates the corresponding routing information according to the information about the SOAP intermediate node and service provider.

104. A SIP request message is sent to the service provider.

The routing controller sends a SIP request message carrying the routing information to the service provider.

105. The service provider returns the routing information.

The service provider returns a SIP response message carrying the routing information to the service requester.

Firstly, in this embodiment, the standard SIP protocol is applied. According to the application QoS requirements, the SOAP message routing path is negotiated dynamically according to the application QoS requirements in view of the capability and status of the SOAP intermediate node and the status of the service provider. That is, a SOAP routing path is created according to the real-time status of the network element node so that SOAP routing is more flexible and conducive to balancing the load of the network and service.

Secondly, the SOAP routing method in this embodiment supports the session-based SOAP routing. Through the standard SIP protocol, one service requester may use different SOAP routing paths in different sessions according to the service logic. For example, different routing paths are allocated according to different session IDs, thus further improving the SOAP interaction efficiency to some extent.

Thirdly, the SIP protocol is combined with the SOAP protocol organically, thus separating the signaling of routing control from the actual routing information, which is conducive to implementing flexible SOAP routing control and large-sized networking.

Finally, according to the service description information and the status of the service provider, the proper service provider instance is selected flexibly, which is conducive to improving efficiency and reliability of service access.

Before the SOAP routing, the following steps of registration and release need to be performed:

1. Register the SOAP intermediate node at specified time:

The SOAP intermediate node sends a SIP-based REGISTER message to the routing controller to get registered, where the REGISTER message identifies that timed registration will be performed in the future. The REGISTER message may carry the capability information of the SOAP intermediate node.

The routing controller extracts the source IP address of the REGISTER message, and stores the status parameter of the SOAP intermediate node according to the source IP address.

The routing controller returns an ACK message to the SOAP intermediate node.

Upon elapsing of a specified time, the SOAP intermediate node is registered again, and the registration process is the same as above.

For better understanding of the registration process of the SOAP intermediate node, a specific instance is described below:

Supposing 8 SOAP intermediate nodes need to be registered and their source IP addresses range from 10.1.3.20 to 10.1.3.27, where the first 4 SOAP intermediate nodes need to be registered with the first routing controller, and the last 4 SOAP intermediate nodes need to be registered with the second routing controller, the SOAP intermediate nodes respectively send REGISTER messages to the corresponding routing controller. The message includes the physical address, logical address, capability set, and node status information.

After receiving the REGISTER message, the first routing controller updates the SOAP intermediate node status table according to the relevant parameters in the message, as shown in Table 1:

TABLE 1

| Physical Address of | | | |
|---|---|---|---|
| SOAP Intermediate | | | |
| Node | Accessible | Capability Set | Node Status |
| 10.1.3.20 | True | Compress: true; | occupation-rate: 10; |
| | | Encryption: false; | |
| 10.1.3.22 | True | Compress: false; | occupation-rate: 20; |
| | | Encryption: false; | |
| 10.1.3.23 | True | Compress: false; | occupation-rate: 30; |
| | | Encryption: false; | |
| 10.1.3.24 | True | Compress: true; | occupation-rate: 60; |
| | | Encryption: false; | |

After receiving the REGISTER message, the second routing controller updates the SOAP intermediate node status table according to the relevant parameters in the message, as shown in Table 2:

TABLE 2

| Physical Address of | | | |
|---|---|---|---|
| SOAP Intermediate | | | |
| Node | Accessible | Capability Set | Node Status |
| 10.1.3.21 | True | Compress: true; | occupation-rate: 10; |
| | | Encryption: false; | |
| 10.1.3.25 | True | Compress: false; | occupation-rate: 20; |
| | | Encryption: false; | |
| 10.1.3.26 | True | Compress: false; | occupation-rate: 30; |
| | | Encryption: false; | |
| 10.1.3.27 | True | Compress: true; | occupation-rate: 60; |
| | | Encryption: false; | |

2. Register the service provider at specified time:

The service provider sends a SIP-based REGISTER message to the routing controller to get registered, where the REGISTER message identifies that timed registration will be performed in the future. Optionally, the REGISTER message carries the capability information of the SOAP intermediate node which needs to be registered at specified time.

The routing controller extracts the source IP address of the message, and stores the status parameter of the service provider according to the source IP address.

The routing controller returns an ACK message to the service provider.

Upon arrival of the specified time, the service provider is registered again, and the registration process is the same as above.

An instance is also given here for clearer description. Supposing two service providers need to be registered and their source IP addresses are 10.1.3.77 and 10.1.3.78 respectively, and the two service providers are registered with the second routing controller whose address is 10.1.3.11, then the two service providers send a REGISTER message to the second routing controller respectively, where the message carries the physical address, logical address, service status (namely, “accessible” in the figure), and service QoS information.

The second routing controller updates the service provider status table, as shown in Table 3:

TABLE 3

| Physical Address | Logical Address | | |
|---|---|---|---|
| of Service | of Service | Accessible | Service QoS |
| 10.1.3.77 | vos@10.1.3.11 | True | occupation-rate: 10; |
| | | | Response: 60 |
| 10.1.3.78 | vos@10.1.3.11 | True | occupation-rate: 20; |
| | | | Response: 30 |

3. The service provider releases a service request:

The service provider sends a SOAP message carrying a service name, a service keyword, and a logical address of the service to the service directory storing unit, thus releasing a service request.

The service directory storing unit stores the service name, logical address of the service, and service keyword.

The service directory storing unit returns the release result to the service provider.

An instance is also given here for clearer description. The first service provider (10.1.3.77) and the second service provider (10.1.3.78) release a service request, carrying a service name, a logical address of the service and a service keyword, to the service directory storing unit.

The service directory storing unit stores the service information table according to the message released by the service provider, as shown in Table 4:

TABLE 4

| Service Name | Logical Address of Service | Service Keyword |
|---|---|---|
| Virtual Trip Service | vos@10.1.3.11 | Vos |

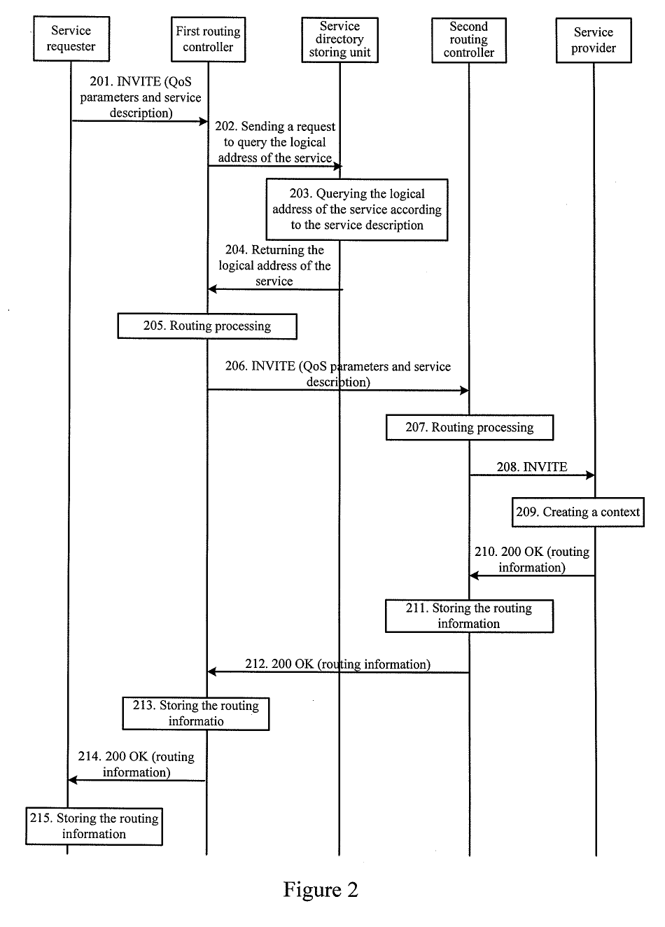

After the foregoing three steps are finished, the SOAP routing process may begin. The SOAP routing method is detailed below through a specific signaling process. As shown in FIG. 2, the process of obtaining SOAP routing information in an embodiment of the present invention includes the following steps:

201. The service requester sends an INVITE message to the first routing controller.

In this embodiment, the first routing controller may be regarded as a home routing controller of the service requester, supposing the SIP request message is an INVITE message. The SIP request message may be other messages, not limited to the INVITE message.

The INVITE message carries the application QoS requirements (including the SOAP intermediate node and service provider), and the service description information of the requested service, specifically, the service keyword and session ID (SessionId).

An instance is given below for better description of the solution.

With reference to the foregoing instance, the service requester sends an INVITE message to the first routing controller, where the message carries the application QoS information, service description information, service keyword of the requested service, and session ID. The service description information includes a service keyword “VOS”. The application QoS information of the service provider includes: the response time is less than 50 ms, and the occupation rate is less than 20%. The application QoS information of the SOAP intermediate node includes: the occupation rate is less than 20%, compression is supported, no encryption is required, and the session ID is XXX.

202. The first routing controller sends a request to query the logical address of the service.

The first routing controller sends a query message to the service directory storing unit, where the query message carries the service keyword extracted from the INVITE message.

In the specific instance, the first routing controller sends a query message to the service directory storing unit, where the query message carries a service keyword “VOS”.

203. The service directory storing unit queries the logical address of the service.

The service directory storing unit queries the service information table according to the service keyword “VOS”, and finds the corresponding logical address of the service.

In the specific instance, the service directory storing unit queries Table 4 according to the service keyword “VOS”, and finds the logical address “vos@10.1.3.11” of the service.

204. The service directory storing unit returns a query result.

The service directory storing unit returns the found logical address of the service to the first routing controller.

205. The first routing controller performs routing processing.

The first routing controller analyzes the SOAP intermediate node requirements of the application QoS first, searches the stored SOAP intermediate node status table for the SOAP intermediate nodes compliant with the application QoS requirements, adds the addresses of the found SOAP intermediate nodes to the Record-Route field of the INVITE message, and determines whether the routing controller itself is a registering routing controller of the service provider according to the logical address of the service.

In the specific instance, the first routing controller (10.1.3.10) determines that it is not a registering routing controller of the service provider according to the logical address (vos@10.1.3.11) of the service. Therefore, the first routing controller analyzes only the SOAP intermediate node requirements of the application QoS, and searches for the SOAP intermediate nodes which have occupation rates lower than 20%, support compression and need no encryption according to the SOAP intermediate node status table. As a result, the first SOAP intermediate node is found compliant with the requirements, and the IP address (10.1.3.20) of the first SOAP intermediate node is added to the Record-Route field of the INVITE message.

206. The first routing controller forwards the INVITE message to the registering routing controller of the service provider (namely, the second routing controller shown in the figure).

That is, if the first routing controller determines that it is not a registering routing controller of the service provider, the first routing controller routes the INVITE message to the next-hop routing controller until the message is routed to the registering routing controller of the service provider.

In the specific instance, the INVITE message is routed to the next routing controller (10.1.3.11) according to the logical address of the service.

207. The second routing controller performs routing processing.

The second routing controller analyzes the service provider requirements of the application QoS, and searches the stored service provider status table for the service providers compliant with the application QoS requirements, and adds the addresses of the found service providers to the Record-Route field of the INVITE message.

In the specific instance, the second routing controller (10.1.3.11) determines that it is a registering routing controller of the service provider according to the logical address (vos@10.1.3.11) of the service, and therefore, analyzes the SOAP intermediate node requirements and service provider requirements of the application QoS. First, the SOAP intermediate node requirements of the application QoS are analyzed. The SOAP intermediate node status table is searched for the SOAP intermediate nodes compliant with the following requirements: the occupation rate is less than 20%, compression is supported and no encryption is required. In the specific instance, it is found that the second SOAP intermediate node meets such requirements. Therefore, the IP address (10.1.3.21) of this SOAP node is added to the Record-Route field of the INVITE message. Then the service provider requirements of the application QoS are analyzed. The stored service provider status table is searched for the service providers compliant with the following requirements: the response time is less than 50 ms and the occupation rate is less than 20%. In the specific instance, it is found that the second service provider meets such requirements. Therefore, the IP address (10.1.3.78) of the second service provider is added to the Record-Route field of the INVITE message.

208. The second routing controller forwards the INVITE message to the service provider.

In the specific instance, the second routing controller routes the INVITE message to the service instance address (10.1.3.78) of the service provider.

209. The service provider creates a context.

In the specific instance, the second service provider extracts the SessionId in the received INVITE message, and creates the corresponding session context in view of its own service logic.

210. The service provider returns an ACK message to the second routing controller.

In the specific instance, the second service provider returns a 200 OK message which carries the routing information and session information.

211-214. The second routing controller forwards the ACK message to the service requester.

215. The service requester stores the routing information.

The service requester extracts the routing information and session information in the 200 OK message, and stores the routing information as indexed by the SessionId.

In the specific instance, the service requester extracts the routing information and session information in the 200 OK message, and stores the routing information as indexed by the SessionId, as shown in Table 5:

TABLE 5

| | Routing Information | | | |
|---|---|---|---|---|
| Session | | Quantity of | Address of | Address of |
| Index | Destination | Intermediate | Intermediate | Intermediate |
| SessionID | Address | Nodes | Node 1 | Node 2 |
| XXX | 10.1.3.78 | 2 | 10.1.3.20 | 10.1.3.21 |

The discussion above describes how the service requester obtains the SOAP routing information. After obtaining the SOAP routing information, the service requester generates a SOAP routing path through negotiation of the SIP message.

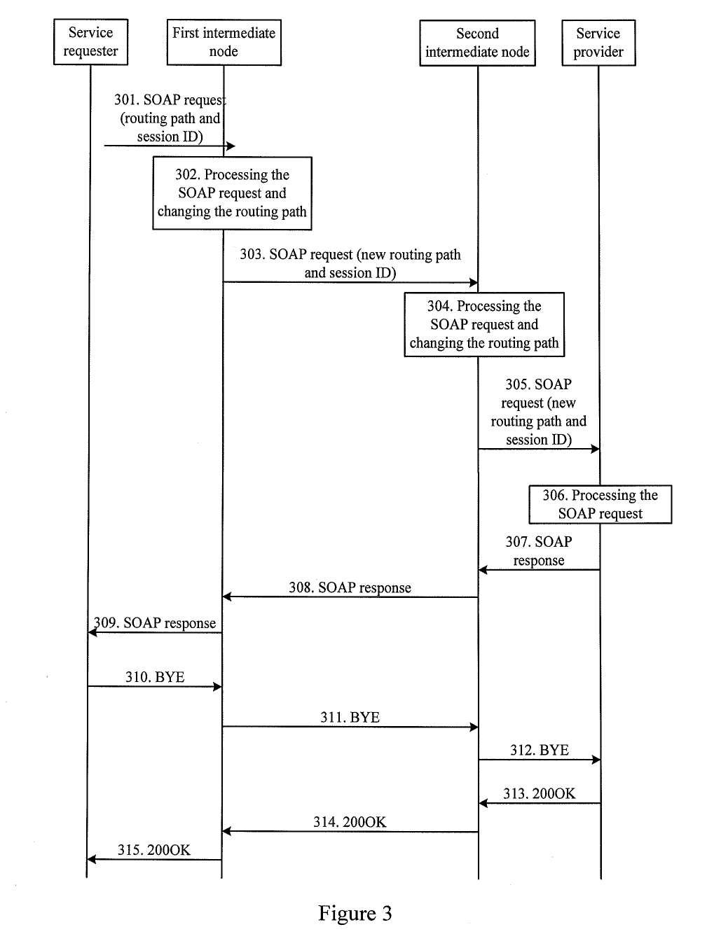

The following describes how the service requester implements the SOAP service through a SOAP routing path. As shown in FIG. 3, the SOAP message routing process in this embodiment includes the following steps:

301. The service requester sends a SOAP request message.

The service requester sends a SOAP request message carrying a routing path and a session ID to the SOAP intermediate node.

302-304. The SOAP intermediate node forwards and processes the SOAP request message.

After receiving the SOAP request message, the SOAP intermediate node changes the routing path in the request message, and processes the SOAP request message.

Likewise, in the specific instance, the first SOAP intermediate node (10.1.3.20) receives the SOAP request message from the service requester, changes the routing path information (namely, removes the address of this node) carried in the message, processes the SOAP request message (namely, compresses the message), and routes the SOAP request message to the next node (10.1.3.21). The second SOAP intermediate node receives the SOAP request message from the first SOAP intermediate node, processes the SOAP request message (namely, decompresses the message), and changes the routing path information (namely, removes the address of this node) carried in the message.

305. The SOAP intermediate node sends the SOAP request message to the service provider.

The SOAP intermediate node sends the processed SOAP request message to the service provider.

In the specific instance, the second SOAP intermediate node sends the SOAP message to the second service provider (10.1.3.78).

306. The service provider processes the SOAP request message.

The service provider processes the SOAP request message according to the created context.

307-309. The service provider sends a SOAP response to the service requester through the SOAP intermediate nodes.

310-315. The session process is ended.

The service requester sends a BYE message to end the session, and delete the corresponding routing information and session information.

Depending on the service logic requirements, the service requester or service provider may terminate the session actively, and delete the corresponding routing information and session information; or if the service provider receives no SOAP request within a specified period, terminate the session passively, and delete the corresponding routing information and session information. The service provider sends a BYE message carrying the SessionId value to the service requester. According to the SessionId value, the service requester deletes the routing information and the service provider deletes the corresponding session context.

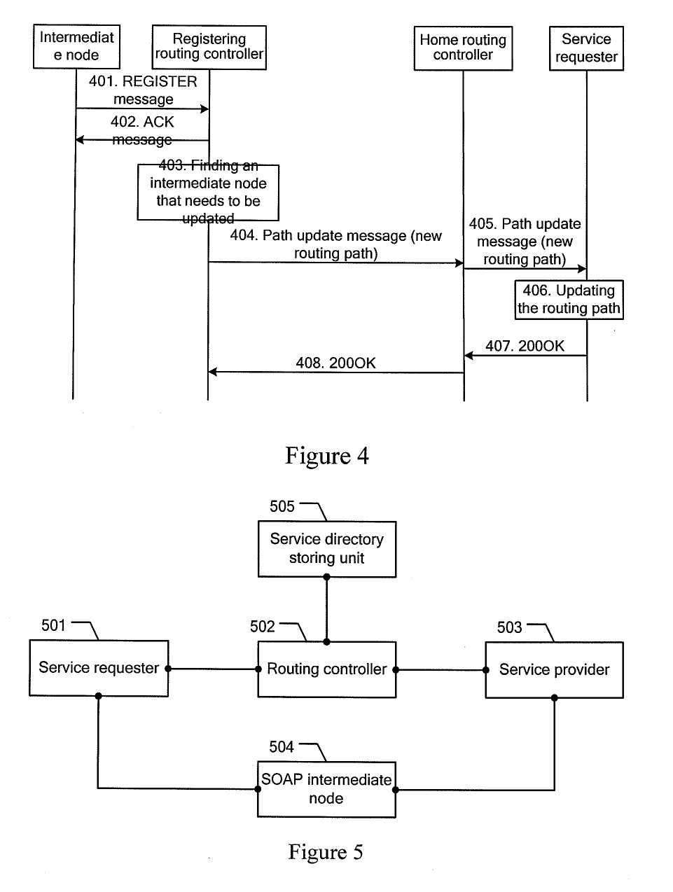

A SOAP routing process has been described above. The process of changing a route is described below. As shown in FIG. 4, the process of changing a route in an embodiment of the present invention includes the following steps:

401. The SOAP intermediate node sends a REGISTER message to the registering routing controller.

The SOAP intermediate node sends a REGISTER message to the registering routing controller, where the message carries the latest status of the SOAP intermediate node.

In the specific instance, the second SOAP intermediate node sends a REGISTER message to the second registering routing controller, where the message carries the latest status (occupation-rate=70%) of the second SOAP intermediate node.

402. The registering routing controller returns an ACK message.

403. The registering routing controller finds an intermediate node that needs to be updated.

404. The registering routing controller forwards a path update message carrying the new routing path to the home routing controller.

405. The home routing controller sends the path update message.

The home routing controller updates the SOAP intermediate node status table.

In the specific instance, the second registering routing controller updates the SOAP intermediate node status table. The updated table is shown in Table 6:

TABLE 6

| Physical Address of | | | |
|---|---|---|---|
| SOAP Intermediate | | | |
| Node | Accessible | Capability Set | Node Status |
| 10.1.3.21 | True | Compress: true; | occupation-rate: 70; |
| | | Encryption: false; | |
| 10.1.3.25 | True | Compress: false; | occupation-rate: 20; |
| | | Encryption: false; | |
| 10.1.3.26 | True | Compress: false; | occupation-rate: 30; |
| | | Encryption: false; | |
| 10.1.3.27 | True | Compress: true; | occupation-rate: 20; |
| | | Encryption: false; | |

The change of the SOAP routing path is triggered. The home routing controller queries the routing information table and SOAP intermediate node status table according to the intermediate node address, and determines whether the intermediate node is on a SOAP path and is incompliant with the application QoS requirements of the path.

In the specific instance, the second routing controller queries the routing information table and SOAP intermediate node status table, and finds that the node is on a SOAP path and is incompliant with the application QoS requirements of the path (occupation-rate<30%).

The routing controller changes the SOAP routing path. The routing controller searches the SOAP intermediate node status table for the SOAP intermediate nodes which comply with the application QoS requirements of the path. If any such node is found, the routing controller changes the SOAP routing path; if no such node is found, the routing controller ends the process without any operation.

In the specific instance, the second routing controller changes the SOAP routing path. The second routing controller searches the SOAP intermediate node status table and finds that the fifth SOAP intermediate node (10.1.3.27) meets the requirements, and therefore, changes the SOAP routing path.

The routing information of the routing information storing unit is changed. Like Table 5, Table 7 shows the changed routing information:

TABLE 7

| | SOAP | Application QoS | Return Path of |
|---|---|---|---|
| SessionId | Routing Path | Requirements | SIP Message |
| XXX | 10.1.3.78 | occupation-rate < 30; | 10.1.3.10 |
| | 10.1.3.21 | Compress: true; | 10.1.3.6 |
| | 10.1.3.20 | encryption: false | |

The routing controller sends a message to the service requester. According to the return path of the SIP message in the routing information table, the routing controller sends a message to the service requester, where the message carries the new routing information and SessionId.

406. The service requester changes the routing information. After receiving the message, the service requester extracts the SessionId and the new routing information, and changes the routing information.

407-408. The service requester returns an ACK message.

The process of changing a route has been described above.

In the foregoing embodiment, the SOAP routing method is detailed. Now the apparatuses provided in an embodiment of the present disclosure are described below.

As shown in FIG. 5, a routing system in an embodiment of the present disclosure includes:

a service requester 501 adapted to send a SIP request message carrying application QoS information and service description information, receive a SIP response message carrying SOAP routing information, send a SOAP request message carrying session-based routing information, and receive a SOAP response;

a routing controller 502 adapted to receive the SIP request message from the service requester 501, select a SOAP intermediate node 504 and a service provider 503 according to the QoS information and service description information in the request message, obtain the SOAP routing information according to the SOAP intermediate node 504 and service provider 503, and send the SIP request message carrying the SOAP routing information to the service provider 503;

the service provider 503 adapted to return a SIP response and a SOAP response which carry the SOAP routing information to the service requester 501;

the SOAP intermediate node 504 adapted to process the SOAP request message sent by the service requester 501, and forward the processed SOAP request message to the service provider 503; and

a service directory storing unit 505 adapted to store the information about the SOAP intermediate node 504 and service provider 503.

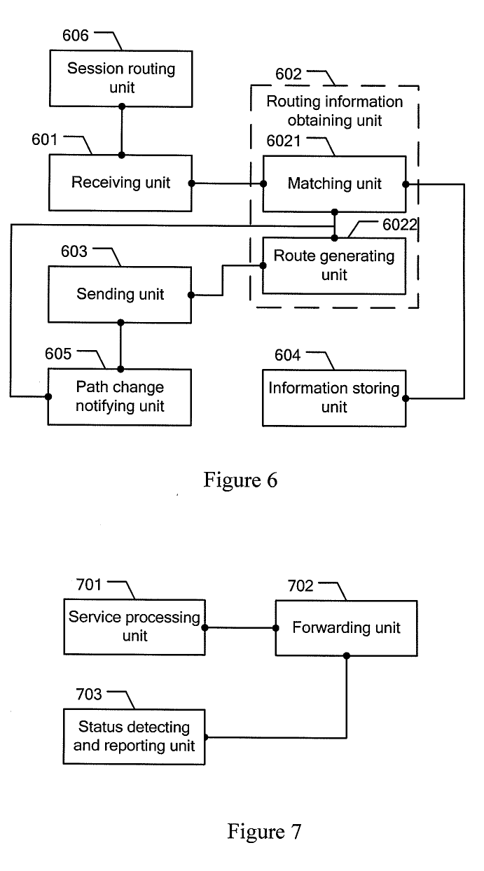

As shown in FIG. 6, a routing controller in an embodiment of the present disclosure includes:

a receiving unit 601 adapted to receive a SIP request message from a service requester;

a routing information obtaining unit 602 adapted to obtain the SOAP routing information according to the QoS parameters and service description information in the SIP request message in view of the capability and status of a SOAP intermediate node and the status of a service provider;

a sending unit 603 adapted to send a SIP request message carrying the SOAP routing information to the corresponding service provider;

an information storing unit 604 adapted to store the information about the status of the registered SOAP intermediate node and service provider, store the routing information in the SIP response message, and change the original SOAP routing information according to the change of the capability and status of the SOAP intermediate node;

a path change notifying unit 605 adapted to notify the service requester to change the SOAP routing path when the SOAP intermediate node or service provider changes; and

a session routing unit 606 adapted to query a service directory storing unit about the logical address of the service according to the service description parameters in the SIP request message, and forward the SIP request message to the next routing controller or service provider according to the logical address of the service.

The routing information obtaining unit 602 includes:

a matching unit 6021 adapted to search for the SOAP intermediate node and service provider in the status information of the SOAP intermediate node and service provider stored in the information storing unit 604 according to the QoS information and service description information in the SIP request message; and

a route generating unit 6022 adapted to generate the corresponding routing information according to the SOAP intermediate node and service provider found by the matching unit 6021.

As shown in FIG. 7, a SOAP intermediate node in an embodiment of the present disclosure includes:

a service processing unit 701 adapted to perform service processing for a received SOAP request message;

a forwarding unit 702 adapted to forward the SOAP request message which has undergone the service processing; and

a status detecting and reporting unit 703 adapted to detect the system status, and report the detection result to a routing controller.

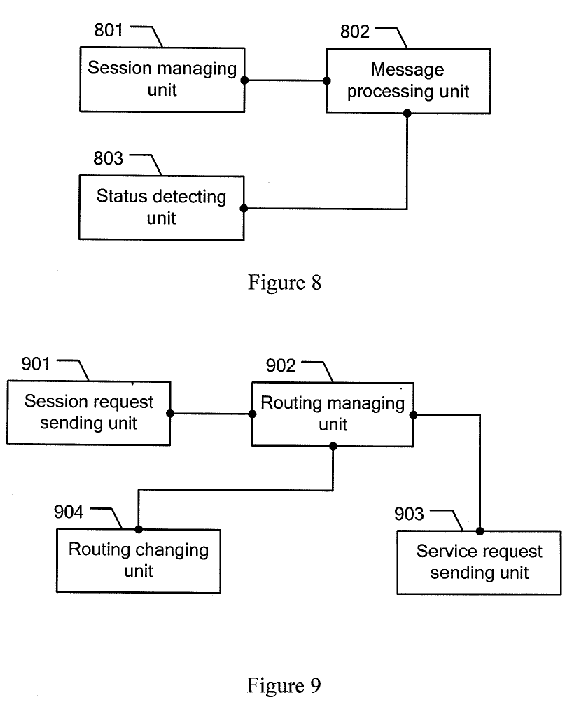

As shown in FIG. 8, a service provider in an embodiment of the present disclosure includes:

a session managing unit 801 adapted to create a session context according to the session ID in a received SIP request;

a message processing unit 802 adapted to process the SOAP request message sent by a service requester according to the session context created by the session managing unit 801; and

a status detecting unit 803 adapted to detect the system status, and report the detection result to a routing controller.

As shown in FIG. 9, a service requester in an embodiment of the present disclosure includes:

a session request sending unit 901 adapted to send a SIP request message;

a routing managing unit 902 adapted to perform route negotiation through the SIP message, and generate and store a session-based SOAP routing path;

a service request sending unit 903 adapted to send a SOAP request message through the SOAP routing path generated by the routing managing unit 902; and a routing changing unit 904 adapted to change the SOAP routing path stored in the routing managing unit 902 according to the notification of a routing controller.

It is understandable to those skilled in the art that all or partial steps of the preceding embodiments can be implemented by hardware instructed by a program. The program may be stored in a computer readable storage medium. When executed, the program includes the following steps:

receiving a SIP request message from a service requester, where the SIP request message carries QoS information and service description information; selecting the corresponding SOAP intermediate node and service provider according to the QoS information and service description information; obtaining the SOAP routing information according to the SOAP intermediate node and service provider; and sending the SIP request message carrying the SOAP routing information to the corresponding service provider.

The storage medium mentioned above may be a Read-Only Memory (ROM), a magnetic disk or a Compact Disk (CD).

It is thus evident that the SOAP routing method, routing system and relevant devices provided in an embodiment of the present disclosure can balance the load between nodes and improve the system performance.

The above is a detailed description of a SOAP routing method, routing system and relevant devices under the present disclosure. Although the disclosure has been described through exemplary embodiments, the disclosure is not limited to such embodiments. It is apparent that those skilled in the art can make various modifications and variations to the disclosure without departing from the spirit and scope of the disclosure. The disclosure is intended to cover the modifications and variations provided that they fall in the scope of protection defined by the following claims or their equivalents.

What is claimed is:

1. A Simple Object Access Protocol (SOAP) routing method, comprising:
receiving a Session Initiation Protocol (SIP) request message from a service requester, wherein the SIP request message carries application Quality of Service (QoS) information and service description information;
selecting a SOAP intermediate node and a service provider according to the application QoS information and the service description information;
obtaining SOAP routing information according to the SOAP intermediate node and the service provider; and
sending the SIP request message carrying the SOAP routing information to the service provider.

2. The SOAP routing method of claim 1, wherein the process of sending the SIP request message which carries the SOAP routing information to the service provider comprises:
querying a logical address of a service according to the service description information in the received SIP request message; and
sending the SIP request message carrying the SOAP routing information to the service provider through the logical address of the service.

3. The SOAP routing method of claim 2, wherein the process of sending the SIP request message which carries the SOAP routing information to the service provider through the logical address of the service comprises:
determining whether a routing controller is a registering routing controller according to the logical address of the service;
if the routing controller is a registering routing controller, searching a service provider status table for the service provider compliant with application QoS parameters, and sending the SIP request message which carries the SOAP routing information to the service provider; or
if the routing controller is not a registering routing controller, forwarding the SIP request message to a next routing controller until the routing controller which receives the SIP request message determines itself as a registering routing controller, whereupon the registering routing controller searches the service provider status table for the service provider compliant with the application QoS parameters and sends the SIP request message carrying the SOAP routing information to the service provider.

4. The SOAP routing method of claim 1, further comprising:
receiving, by the service requester, a SIP response message returned by the service provider;
extracting the SOAP routing information in the SIP response message;
generating a session-based SOAP routing path according to the SOAP routing information; and
sending a SOAP request message to the service provider through the SOAP routing path, wherein the SOAP request message carries a session ID and the SOAP routing path.

5. The SOAP routing method of claim 4, wherein the process of generating the session-based SOAP routing path according to the SOAP routing information comprises:
negotiating the SOAP routing path with the routing controller through a SIP message; and
generating the session-based SOAP routing path according to the negotiation result.

6. The SOAP routing method of claim 1, further comprising:
creating, by the service provider, a corresponding session context according to the session ID in the received SIP request message carrying the SOAP routing information in view of a service logic of the service provider.

7. The SOAP routing method of claim 6, further comprising:
processing, by the service provider, the SOAP request message according to the session context.

8. The SOAP routing method of claim 4, wherein the process of sending the SOAP request message to the service provider through the SOAP routing path comprises:
sending the SOAP request message to the corresponding SOAP intermediate node according to the SOAP routing path; and
by the SOAP intermediate node, changing the routing path in the request message and forwarding the processed request message to the service provider.

9. The SOAP routing method of claim 6, further comprising:
deleting, by the service provider, the routing information and session context after the session is ended.

10. The SOAP routing method of claim 1, further comprising:
selecting, by the routing controller, a new SOAP intermediate node compliant with the application QoS information requirements after the existing SOAP intermediate node changes; and
notifying, by the routing controller, the service requester to change the SOAP routing path according to the new SOAP intermediate node.

11. A routing system, comprising:
a service requester adapted to send a Session Initiation Protocol (SIP) request message carrying application Quality of Service (QoS) parameters and service description information, receive a SIP response message carrying Simple Object Access Protocol (SOAP) routing information, send a SOAP request message carrying session-based routing information, and receive a SOAP response message;
a routing controller adapted to receive the SIP request message from the service requester, select a SOAP intermediate node and a service provider according to the application QoS information and service description information, obtain SOAP routing information according to the SOAP intermediate node and service provider, and send the SIP request message carrying the SOAP routing information to the service provider; and
the service provider adapted to return the SIP response message and SOAP response message which carry the SOAP routing information to the service requester.

12. The routing system of claim 11, further comprising a SOAP intermediate node adapted to process the SOAP request message sent by the service requester and forward the processed SOAP request message to the service provider.

13. The routing system of claim 11, further comprising a service directory storing unit adapted to store information about the SOAP intermediate node and the service provider.

14. A routing controller, comprising:
a receiving unit adapted to receive a Session Initiation Protocol (SIP) request message from a service requester;
a routing information obtaining unit adapted to obtain Simple Object Access Protocol (SOAP) routing information according to application Quality of Service (QoS) information and service description information in the SIP request message in view of capability and status of a SOAP intermediate node and status of a service provider;
a sending unit adapted to send the SIP request message carrying the SOAP routing information to the service provider corresponding to a SOAP route.

15. The routing controller of claim 14, further comprising:
an information storing unit adapted to store information about status of a registered SOAP intermediate node and service provider, store routing information in a SIP response message, and change the original SOAP routing information according to change of capability and status of the SOAP intermediate node.

16. The routing controller of claim 15, wherein the routing information obtaining unit comprises:
a matching unit adapted to search for the SOAP intermediate node and the service provider in status information of the SOAP intermediate node and service provider stored in the information storing unit according to the application QoS information and service description information in the SIP request message; and
a route generating unit adapted to generate the routing information according to the SOAP intermediate node and service provider found by the matching unit.

17. The routing controller of claim 14, further comprising a path change notifying unit adapted to notify the service requester to change a SOAP routing path when the SOAP intermediate node or service provider changes.

18. The routing controller of claim 14, further comprising:
a session routing unit adapted to query a service directory storing unit about a logical address of a service according to the service description information in the SIP request message and forward the SIP request message to a next routing controller or service provider according to the logical address of the service.
